(19) United States
(12) Patent Application Publication
(10) Pub. No.: US 2005/0143127 A1
(43) Pub. Date: Jun. 30, 2005

(54) Wireless network module

(76) Inventor: Jui-Long Ou, Hsinchu City (TW)

Correspondence Address: RABIN & BERDO, P.C., Suite 500, 1101 14 Street, N.W., Washington, DC, 20005, US

(21) Appl. No.: 10/999,925

(22) Filed: Dec. 1, 2004

(30) Foreign Application Priority Data
Dec. 31, 2003 (TW) 92137564
Oct. 5, 2004 (TW) 93130147

(51) Int. Cl. H04B 7/00; H04B 1/38; H04M 1/00; H04Q 7/20

(52) U.S. Cl. 455/557; 455/550.1

(57) ABSTRACT

A wireless network module is provided to enable at least one electronic device to access wireless services. In an embodiment, a control unit is connected with a first interface connecting to the electronic device, a second interface selectively connecting to another electronic device having a second communication unit the, and a first communication unit providing the ability of first communication, thereby the electronic device connects to the network by the first communication unit, and when the first communication unit cannot be executed the electronic device connects to the network via the second communication unit of another electronic device. Further, the electronic device connected with the second interface also can access wireless services via the first communication unit.

### BACKGROUND OF THE INVENTION

1. Field of Invention

The invention relates to a wireless network module, and more particularly to a wireless network module that enables the electronic device to use wireless access services when they combine with each other.

2. Description of the Related Art

The rapid development in network technology has brought human beings a lot of change and convenience in life. In the past, the network always requires a network cable or telephone cable for the data transmission. Nowadays, as applications of electromagnetism develop, it has opened a new world of network—the wireless/mobile Internet, in which the data transmission is by electromagnetic waves rather than by a network cable or telephone cable.

Wireless/mobile Internet is the idea of using wireless telecommunication techniques and wireless data communication techniques to enable users to access a network for communications, shopping or work using a terminal device, such as a notebook computer, a personal digital assistant (PDA), etc. The wireless telecommunication includes the general packet radio service (GPRS), the global system for mobile communication (GSM), the code division multiple access (CDMA), and the personal handyphone system (PHS), etc. The wireless data communication is such as the wireless local area network (WLAN). Currently, the mostly ways to access the wireless/mobile Internet for users are the GPRS and WLAN, There are advantages and disadvantages respectively. Users select either one of them according to their own preferences.

GPRS is a technology that equips the terminal device with both communication and data transmission functions. A mobile base station sends signals and uses the packet switch method to replace the circuit switch method in the conventional wired network.

In the WLAN, a terminal device is combined with an access point (AP) by a wireless network card to perform local area wireless network connection. Then, the AP connects to an external access circuit (e.g. ADSL and devoted lines), thereby the terminal device can access the network and the users can use wireless network resources with the terminal device. In other words, the transmission portion of the user end to the network is converted into a wireless transmission form. Therefore, it has the problem in mobility that a wired network does not have. However, the transmission range in the wireless network is restricted by the distance between the AP and the computer.

Technically speaking, the transmission range in using GPRS can reach 10 km with a nominal speed of 144 Kbps. In using WLAN, the transmission speed is higher. For example, the transmission speed in 802.11g can reach 54 Mbps. Nevertheless, the transmission range is shorter, only within 100 m around the AP. In addition, the WLAN utilizes the free 2.4 GHz frequency band. Its coverage range is small and the installation cost is low. Although the GPRS costs higher, its application range is wider and its safety is higher. Besides, the GPRS charges by the transmitted data packet quantity, whereas the WLAN charges by the actual communication time. Therefore, the WLAN cost is usually much lower than the GPRS for ordinary users.

To achieve the hope of accessing the network all the time at a lower cost, many terminal devices have a built-in WLAN wireless network card and allows the insertion of an external GPRS wireless network, or have a GPRS+WLAN wireless network card. In this case, the terminal device uses the WLAN mode to access the network if the WLAN network is available. Otherwise, the terminal device uses the GPRS mode to access the network.

However, using the mode of built-in WLAN wireless network card and external GPRS wireless network card, the user has to purchase two network cards and bring the GPRS wireless network card just in case of need. Also, a lot of space will be occupied when two cards are used simultaneously.

The GPRS+WLAN double-mode network card integrates the GPRS and WLAN modules on one interface. As the GPRS module involves more technical difficulty and both GPRS and WLAN are different in their manufacturing processes, working frequencies, and modulation coding, there are the existing problem how to minimize the volume and cost of the combination, how to make the use easier, how to maintain a low power consumption, and how to position the WLAN. The GPRS is performed in 900 MHz, 1800 MHz, or 1900 MHz of frequency bands. The WLAN also includes the 802.11a, 802.11b, and 802.11g standards, each of which has the 2.4 GHz and 5 GHz frequency bands. Moreover, there are PCMCIA, CF, and USB interfaces. Therefore, there are too many possible combinations. Accordingly, the integrating process for the network card that includes more combinations will be more difficult and expensive, whereas those including fewer combinations are more restrictive and less convenient.

To ensure that the wireless network apparatuses developed by different manufacturers are compatible and stable, they have to be tested by a standard examination institute to check whether they meet the requirements (the wireless data communication standards or wireless telecommunication standards). Therefore, if the wireless data communication (e.g. WLAN) function and the wireless telecommunication (e.g. GPRS) function are integrated in one product, it has to be tested once the standard of one of them is changed. This will increase the replacing rate of products. It will also cause troubles in product research, development and sale.

As disclosed in R.O.C. patent no. 586640, a converter structure that integrates the wireless network card and the PHS communication module installed two standards converter and can set up a printed circuit board (PCB) of the WLAN in its interior. Therefore, one end of the WLAN card can be connected to various kinds of electronic devices, while the other end can be connected to a PHS communication module so that all the connected electronic devices can access the network.

Therefore, how to let a user more effectively use wireless telecommunication technology and wireless data communication technology to enjoy network services has become a very important research direction in wireless network products.

### SUMMARY OF THE INVENTION

In view of the foregoing, an objective of the invention is to provide a wireless network module to solve the various restrictions and drawbacks existing in the prior art.

The wireless network module according the present invention provides a wireless communication device to meet the needs of integrating data communications and telecommunications of the market. It is built in with a WLAN module to provide wireless network functions. When it is combined with an electronic device, the electronic device immediately has the wireless networking function. Herein, the electronic devices include computers, such as laptop computers and personal computers, mobile communication devices, e.g. PDA, cell phones, etc, and that require the use of a wireless network.

Another objective of the present invention is to provide a wireless network module as a converter. When an electronic device is placed in an environment without ability of a wireless network module, the electronic device can use such wireless network module to combine with an electronic device with a wireless telecom module. Thus, the electronic device can enjoy network services via the wireless telecom module. Moreover, when entering the network area with ability of a wireless network module again, the electronic device can immediately switch to use the wireless network module for wireless networking.

To achieve the above objectives of the present invention, there is provided a wireless network module to enable more than one electronic device with networking functions. It includes: a control unit; a first interface connected to the control unit; a second interface connected to the control unit, wherein one of the first interface and the second interface is connected to the electronic device; and a first wireless communication unit connected to the control unit to provide a first wireless communication function and control the signals between the first wireless communication unit and the interfaces, thereby the electronic device to connect to a network via the first wireless communication unit.

When the first wireless communication unit cannot provide services, the electronic device is connected to another electronic device with a second wireless communication unit via the second interface. Thus, the electronic device can connect to the network using the second wireless communication unit.

The invention further provides a wireless network module to enable an electronic device with the networking functions. It includes: a first wireless communication unit; a control unit connected to the first wireless communication unit; a first interface connected to the control unit for the connection of an electronic device; and a second interface connected to the control unit for the connection of another electronic device. The second electronic device includes a second wireless communication unit. The control unit controls the signals between the first wireless communication unit and the interfaces, so that the electronic device can connect to the network via the second wireless communication unit of another electronic device.

Moreover, a wireless network module according the present invention includes an antenna connected to the first wireless communication unit.

In a wireless network module according the present invention, the control unit includes a control device; and a memory device. The control device controls the signals between the first wireless communication unit and the interfaces. The memory device saves information obtained by the electronic device via the first wireless communication unit.

### BRIEF DESCRIPTION OF THE DRAWINGS

The invention will become more fully understood from the detailed description given herein below. However, this description is for purposes of illustration only, and thus is not limitative of the present invention, wherein:

FIG. 1 is a block diagram of the wireless network module according to an embodiment of the invention;

FIG. 2 is a block diagram of the wireless network module according to an embodiment of the invention;

FIG. 3 is a block diagram of the wireless network module according to an embodiment of the invention;

FIG. 4 is a block diagram of the wireless network module according to an embodiment of the invention;

FIG. 5 is a block diagram of the wireless network module according to an embodiment of the invention; and

FIG. 6 is a block diagram of the wireless network module according to an embodiment of the invention.

### DETAILED DESCRIPTION OF THE INVENTION

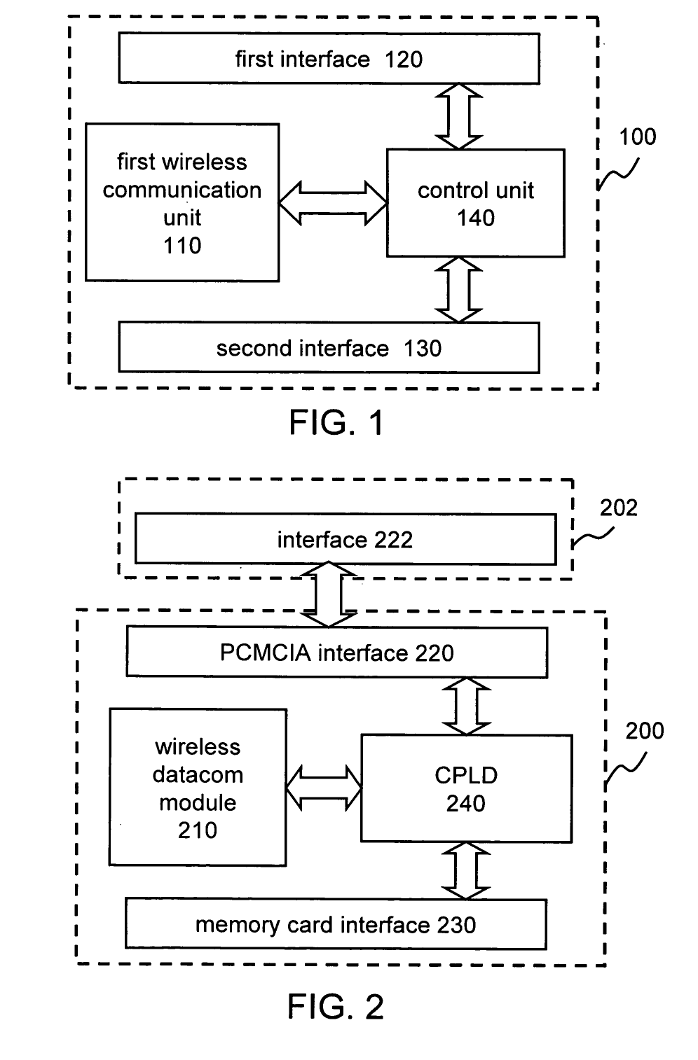

With reference to FIG. 1, a wireless network module according to an embodiment of the invention enables an electronic device for networking functions. It includes a first wireless communication unit 110, a first interface 120, a second interface 130, and a control unit 140. Herein, all of them can be installed on a body 100.

The first wireless communication unit 110 is used to let the electronic device connect to a network using a communication standard compliant with the first wireless communication unit. The first wireless communication unit includes a wireless datacom module, and that which can provide the wireless datacom function. Besides, the wireless datacom module includes a wireless network module with more than one standard. The wireless data communication standards include 802.11a, 802.11b, 802.11g, etc. The wireless datacom module can use a control chipset to support various kinds of wireless data communication standards. The control chipset includes the Broadcom chip, the Intersil chip, the Zydas chip, SiS16XU chip, the Realtek chip, the RICOH chip, and that which can support various kinds of wireless data communication standards.

The first and second interfaces 120, 130 can be slot interfaces for the connection of an electronic device. The connected electronic device also has the same or a compatible interface. In particular, the first and second interfaces 120, 130 have such interface standards as CF, MS, Mspro, SM, MMC, SDIO, PCMCIA, and CardBus. Moreover, one may use a combo interface to increase the compatibility of the different interfaces on the electronic device. For example, the combo interface can be a six-in-one memory interface.

The electronic device externally connected to the interfaces 120, 130 includes a computer, such as a laptop and personal computer, a mobile communication device, such as a PDA and cell phone, and a terminal device which require the use of a wireless network. When the electronic device is connected to one of the interfaces 120, 130, it attains the first wireless communication function via the first wireless communication unit 110.

The control unit 140 is used to control signals between the first wireless communication unit 110 and the interfaces 120, 130. It includes a dispatch circuit, which can be a complex programmable logic device (CPLD), an application specific integrated circuit (ASIC), or that which enables the address, data and control signal to communicate between the first wireless communication unit 110 and the interfaces 120, 130. The control unit 140 can rely on a programming for communicating the address, data and control signal between the first wireless communication unit 110 and the interfaces 120, 130.

When the first wireless communication unit 110 cannot provide services, one of the first and second interfaces 120, 130 is connected to an electronic device with the second wireless communication unit. In this case, the control unit 140 is used to control the signals between the first wireless communication unit 110 and the interfaces 120, 130 so that the other electronic device connected to the other interface of the interfaces 120, 130 can connect to the network via the second wireless communication unit.

The second wireless communication unit can be a wireless telecom device which can be the mobile communication module with more than one communication standard. The types of the mobile communication module include GPRS, CDMA, PHS, or GSM. Therefore, the mobile communication module can be a PDA or a cell phone.

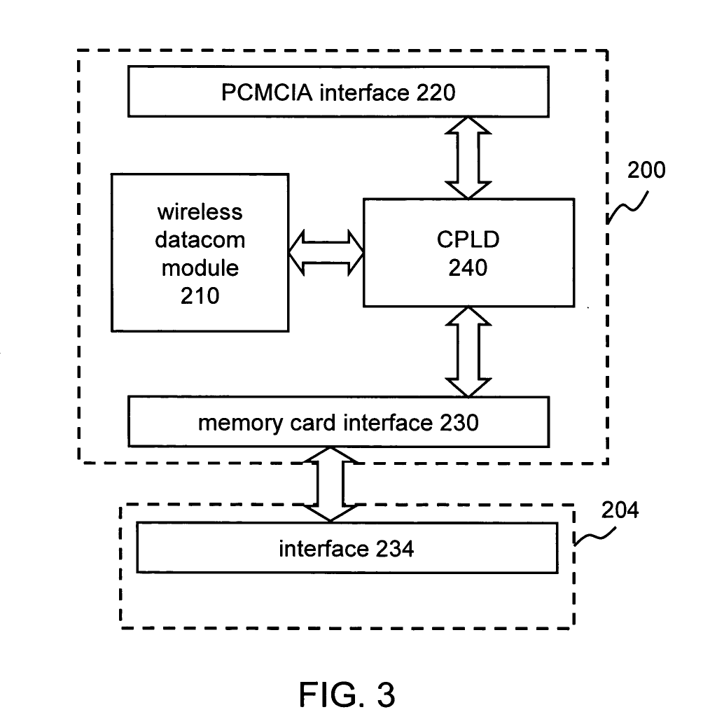

The wireless network module of an embodiment of the invention is shown in FIGS. 2 and 3. In this embodiment, It assumes that the first and second interfaces of the wireless network module are respectively a PCMCIA interface 220 and a memory card interface 230, that it is built in with a wireless datacom module 210, and that it uses a CPLD 240 as the control unit to communicate the address, data and control signals between the PCMCIA interface 220, the memory card interface 230, and the wireless datacom module 210. All the wireless datacom module 210, PCMCIA interface 220, memory card interface 230, and CPLD 240 are installed on a body 200.

The host of a computer 202, say a laptop computer or a personal computer, can use its interface 222 the same or compatible as the PCMCIA interface 220 to connect to the PCMCIA interface 220 on the wireless network module. Therefore, it can use the network functions of the communication standard of the first wireless communication unit via the wireless datacom module 210. That is, it obtains the wireless networking function by the wireless datacom module 210, as shown in FIG. 2.

Moreover, a mobile communication device 204, such as a PDA or cell phone, can use its interface 234 the same or compatible as the memory card interface 230 to combine with the wireless network module, thereby use the network functions of the communication standard of the wireless datacom module 210. That is, it obtains the wireless networking function using the wireless datacom module 210 on the body 200. The wireless communication function of a mobile communication device is thus extended by the wireless network module, as shown in FIG. 3.

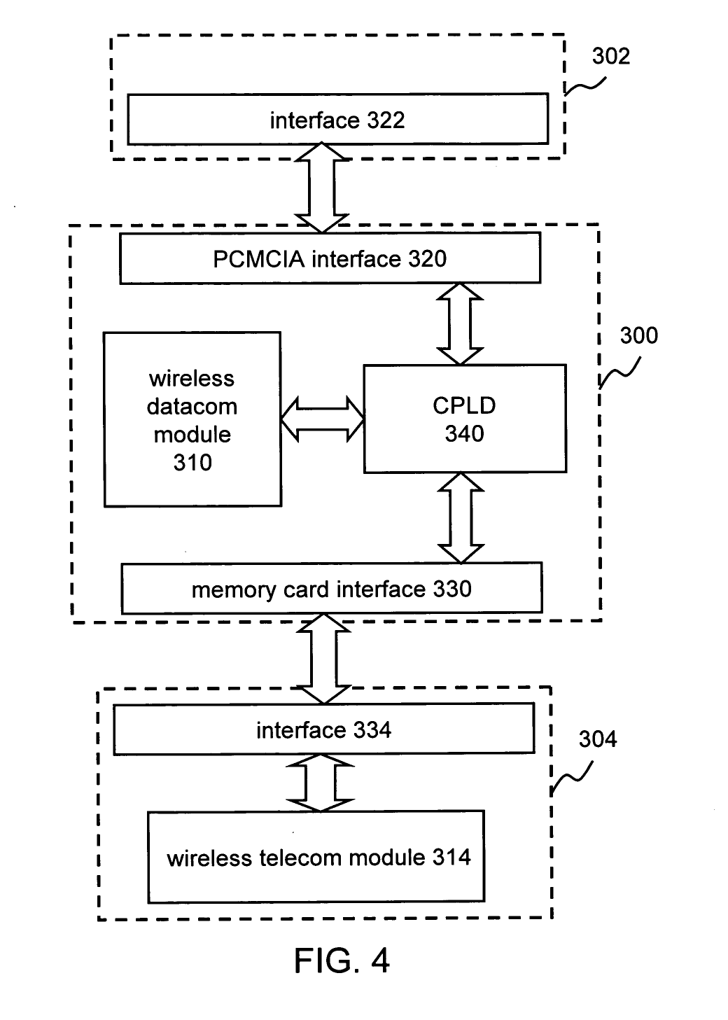

In another embodiment shown in FIG. 4, it assumes that the first and second interfaces of the wireless network module are, respectively, a PCMCIA interface 320 and a memory card interface 330. The wireless network module is built in with a wireless datacom module 310. It uses a CPLD 340 as the control unit to communicate the address, data and control signals between the PCMCIA interface 320, the memory card interface 330, and the wireless datacom module 310. All the wireless datacom module 310, PCMCIA interface 320, memory card interface 330, and CPLD 340 are installed on a body 300.

The host of a computer 302, say a laptop computer or a personal computer, can use its interface 322 the same or compatible as the PCMCIA interface 320 to combine with the wireless network module, thereby it can use the network functions of the communication standard of the first wireless communication unit via the wireless datacom module 310. That is, it obtains the wireless networking function using the wireless datacom module 310 on the body 300.

When the wireless datacom module 310 cannot provide services, it combines with an electronic device with the second wireless communication unit, i.e. an electronic device 304 with a wireless telecom module 314 such as a PDA or cell phone, by the memory card interface 330. When the computer 302 is connected to the electronic device 304 via the network wireless module, the control unit on the body 300, i.e. the CPLD 340, can communicate address, data, and control signals among the PCMCIA interface 320, the memory card interface 330, and the wireless datacom module 310. Thus, the computer 302 can recognize the wireless datacom module 310 and the wireless telecom module 314 and make them function independently. In other words, the computer also can obtain the wireless networking functions via the wireless telecom module 314.

Using the design of the control unit, the electronic device connected to the wireless network module preferably uses the first wireless communication unit. That is, when it detects the wireless datacom module 310 can provide the services again, the CPLD 320 on the body 300 detects the control signal sent by the wireless datacom module 310 and switches the computer 302 that originally uses the wireless telecom module 334 for networking to use the wireless datacom module 310.

The interface on the body can be a compound interface, such as a six-in-one memory card interface, to increase the compatibility with different interfaces of various electronic devices.

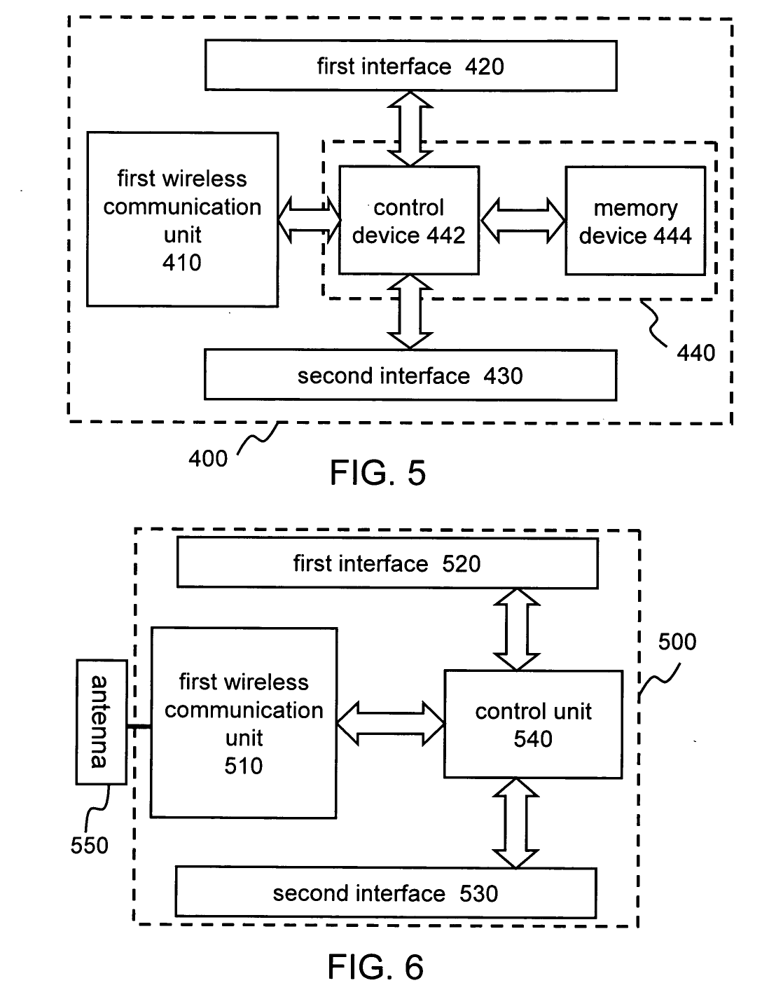

FIG. 5 also shows a wireless network module of an embodiment of the invention that enables an electronic device to connect to a network. It includes a first wireless communication unit 410, first and second interfaces 420, 430, and a control unit 440.

Since the first wireless communication unit 410, the first interface 420, and the second interface 430 are the same as those in FIG. 1, we do not describe their configurations and functions again.

The control unit 440 includes a control device 442 and a memory device 444. The control device 442 controls the signals between the first wireless communication unit 410 and the interfaces 420, 430. It can be a dispatch circuit. The memory device 444 is used to store information obtained by the electronic device via the first wireless communication unit 410. It can be a memory device.

To enhance the action of the first wireless communication unit of an embodiment of the invention, an antenna 550 can be installed on the body, as shown in FIG. 6. The antenna 550 can be installed at different locations on the body 500 according to practical needs.

In summary, such wireless network module can be used in various kinds of electronic devices so that they can connect to a network. If it is used in a mobile communication device, such as a PDA or a cell phone, the mobile communication device obtains the wireless networking function, expanding its wireless communication functions. The wireless network module enables an electronic device to have both the wireless data communication function and the wireless telecommunication function. That is, an electronic device can use the wireless network module to connect to another electronic device with the wireless telecommunication function. In this case, the electronic device can use the wireless network module to enjoy the wireless telecommunication function by using the connected electronic device with the wireless telecommunication function.

Of course, one can decide to have a built-in wireless telecommunication module in the wireless network module and to externally connect to an electronic device with a wireless network module.

Moreover, a wireless network module according the invention includes a built-in memory device to store information obtained by the electronic device from the network.

To enhance the function of the first wireless communication unit, an antenna can be installed on the body for the first wireless communication unit.

It is thus seen that the wireless network module according the invention is not directly integrating two kinds of wireless communications functions. Instead, a flexible extension means is employed for the convenience of modifying only the communication standard that is changed. This can save a lot of the production development cost. The users do not have to keep purchasing new products in response to the changes in the wireless telecommunication or wireless data communication standards. The invention can be readily upgraded.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A wireless network module for at least one electronic device to connect to a network, comprising:
a control unit;
a first interface connected to the control unit;
a second interface connected to the control unit, wherein one of the first interface and the second interface is connected to the electronic device; and
a first wireless communication unit connected to the control unit to provide a first wireless communication function, wherein the control unit controls signals between the first wireless communication unit and the first and second interfaces so that the electronic device connects to the network via the first wireless communication unit.

2. The wireless network module of claim 1, wherein the electronic device connects to another electronic device with a second wireless communication unit when the first wireless communication unit is unable to provide services, so that the electronic device connects to the network via the second wireless communication unit.

3. The wireless network module of claim 2, wherein the first wireless communication unit is a wireless datacom module and the second wireless communication unit is a wireless telecommunication device.

4. The wireless network module of claim 3, wherein the wireless datacom module has more than one wireless data communication standard and the wireless telecommunication device has more than one wireless telecommunication standard.

5. The wireless network module of claim 2, wherein the first wireless communication unit is a wireless telecommunication device and the second wireless communication unit is a wireless datacom module.

6. The wireless network module of claim 5, wherein the wireless datacom module has more than one wireless data communication standard and the wireless telecommunication device has more than one wireless telecommunication standard.

7. The wireless network module of claim 1, wherein the first wireless communication unit is a wireless datacom module.

8. The wireless network module of claim 1, wherein the first and second interfaces are compound interface compliant with more than one interface standard.

9. The wireless network module of claim 1, wherein the control unit controls the address, data and control signals to communicate between the first wireless communication unit and the first and second interfaces using software.

10. The wireless network module of claim 1, wherein the control unit is a dispatch circuit.

11. The wireless network module of claim 10, wherein the dispatch circuit is a complex programmable logic device (CPLD).

12. The wireless network module of claim 10, wherein the dispatch circuit is an application specific integrated circuit (ASIC).

13. The wireless network module of claim 1, wherein the control unit includes:
a control device to control the signals between the first wireless communication unit and the first and second interfaces; and
a memory device connected to the control device to store information obtained by the electronic device from the network.

14. The wireless network module of claim 13, wherein the control device is a dispatch circuit.

15. The wireless network module of claim 14, wherein the dispatch circuit is a CPLD.

16. The wireless network module of claim 14, wherein the dispatch circuit is an ASIC.

17. The wireless network module of claim 1 further comprising an antenna connected to the first wireless communication unit.

18. A wireless network module for an electronic device to connect to a network, comprising:
a first wireless communication unit;
a control unit connected to the first wireless communication unit;
a first interface connected to the control unit for the connection of the electronic device; and
a second interface connected to the control unit for the connection of another electronic device, wherein the other electronic device includes a second wireless communication unit, and the control unit controls signals between the first wireless communication unit and the first and second interfaces so that the other electronic device connects to the network via the second wireless communication unit.

19. The wireless network module of claim 18, wherein the first wireless communication unit is a wireless datacom module and the second wireless communication unit is a wireless telecommunication device.

20. The wireless network module of claim 19, wherein the wireless datacom module has more than one wireless data communication standard and the wireless telecommunication device has more than one wireless telecommunication standard.

21. The wireless network module of claim 18, wherein the first wireless communication unit is a wireless telecommunication device and the second wireless communication unit is a wireless datacom module.

22. The wireless network module of claim 21, wherein the wireless datacom module has more than one wireless data communication standard and the wireless telecommunication device has more than one wireless telecommunication standard.

23. The wireless network module of claim 18, wherein the first and second interfaces are compound interface compliant with more than one interface standard.

24. The wireless network module of claim 18, wherein the control unit is a dispatch circuit.

25. The wireless network module of claim 24, wherein the dispatch circuit is a CPLD.

26. The wireless network module of claim 24, wherein the dispatch circuit is an ASIC.

27. The wireless network module of claim 18, wherein the control unit includes:
a control device to control the signals between the first wireless communication unit and the first and second interfaces; and
a memory device connected to the control device to store information obtained by the electronic device from the network.

28. The wireless network module of claim 27, wherein the control device is a dispatch circuit.

29. The wireless network module of claim 28, wherein the dispatch circuit is a CPLD.

30. The wireless network module of claim 28, wherein the dispatch circuit is an ASIC.
